(19) United States
(12) Patent Application Publication
(10) Pub. No.: US 2008/0018916 A1
(43) Pub. Date: Jan. 24, 2008

(54) Image forming apparatus and paper-feeding method thereof

(75) Inventor: Yong-duk Lee, Gunpo-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/712,901

(22) Filed: Mar. 2, 2007

(30) Foreign Application Priority Data
Jul. 24, 2006 (KR) 2006-69329

(51) Int. Cl. G06F 3/12

(52) U.S. Cl. 358/1.1

(57) ABSTRACT

An image forming apparatus which does not require securing a separate space for feeding a print medium, and a paper-feeding method thereof are disclosed. The image forming apparatus comprises: an image forming apparatus body; an image forming unit provided within the image forming apparatus body; and a paper-feeding unit movably installed in relation to the image forming apparatus body, the paper-feeding unit feeding a print medium to the image forming unit after turning the print medium in a reverse direction at least one time.

### CROSS-REFERENCE TO RELATED APPLICATIONS

This application claims the benefit of Korean Patent Application No. 2006-69329, filed Jul. 24, 2006 in the Korean Intellectual Property Office, the disclosure of which is incorporated herein by reference.

### BACKGROUND OF THE INVENTION

1. Field of the Invention

Aspects of the present invention relate to an image forming apparatus and a paper-feeding method thereof.

2. Description of the Related Art

Recently, mobile image forming apparatuses have been widespread, wherein a user can freely connect a mobile camera, such as a digital camera or a portable phone provided with a camera, to such a mobile image forming apparatus so as to develop one or more photographs on the spot. U.S. Pat. No. 6,918,645 discloses an image forming apparatus which is configured to be operated by battery so that it can be conveniently and easily carried. FIG. 1 shows such an image forming apparatus.

In FIG. 1, reference numeral 1 denotes an image forming apparatus body and reference numeral 3 denotes a paper-feeding cassette.

As shown in the drawing, the image forming apparatus body 1 incorporates an image forming unit for forming a given image on a print medium, and the paper-feeding cassette 3, in which print media are loaded, is removably fitted in a mounting opening 1a formed through a side wall 1a of the image forming apparatus 1. A pick-up roller 3a is provided in the mounting opening 1a so as to pick up a print medium from the paper-feeding cassette 3.

With this arrangement, if a user positions the image forming apparatus body 1 in a desired place and then fits the paper-feeding cassette 3 into the mounting opening 1a, the pick-up roller 3a feeds a print medium loaded in the paper-feeding cassette 3 into the image forming apparatus body 1, whereby a desired image can be printed on the print medium on the spot.

However, such a conventional image forming apparatus is disadvantageous and inconvenient in that because the paper-feeding cassette 3 is separately mounted to the image forming apparatus body 1, it is necessary to secure a space for mounting the paper-feeding cassette 3 and to carry the paper-feeding cassette 3 separately.

### SUMMARY OF THE INVENTION

Aspects of the present invention provide an image forming apparatus improved in construction in such a manner that it is not necessary to secure a space for feeding a print medium.

According to an aspect of the present invention, there is provided an image forming apparatus comprising an image forming apparatus body; an image forming unit provided within the image forming apparatus body; and a paper-feeding unit movably installed in relation to the image forming apparatus body, the paper-feeding unit feeding a print medium to the image forming unit after turning the print medium in a reverse direction at least one time.

According to another aspect of the present invention, paper-feeding unit comprises a pick-up roller mounted within the image forming apparatus body in such a manner as to be bi-directionally rotatable, so that when the pick-up roller rotates in a first direction, the pick-up roller moves the print medium to a pick-up position and when the pick-up roller rotates in a second direction, the paper-feeding unit picks up the print medium at the pick-up position and feeds the print medium to the image forming unit.

Here, the image forming apparatus may further comprise: a pick-up sensor for sensing whether the print medium has moved to the pick-up position; and a controller for selectively controlling the driving direction of the pick-up roller in the forward/reverse direction on the basis of a sensing signal from the pick-up sensor.

In addition, the image forming apparatus may further comprise a paper sensor for sensing whether the print medium fed by the pick-up roller is admitted into a print position in the image forming unit, wherein the controller stops the driving of the pick-up roller on the basis of a sensing signal for the print medium, which is applied from the print sensor.

The pick-up roller may be arranged to be spaced from the print medium received in the paper-feeding unit, so that the pick-up roller can move the print medium to the pick-up position when it reversely rotates at least one time.

The image forming apparatus or the paper-feeding unit may be provided with a retreating path for the tail edge of the print medium moved in the first direction by the pick-up roller.

Here, the retreating path may comprise a guide slit provided in the image forming apparatus body or the paper-feeding unit so as to guide the tail edge of the print medium to the outside.

The retreating path may further comprise an inclined part for guiding the tail edge of the print medium moving in the first direction to the guide slit; the inclined part provides a frictional force so as to prevent double-feeding.

The image forming apparatus may further comprise a paper-feeding guider provided between the image forming apparatus body and the paper-feeding unit for guiding the leading edge of the print medium to the image forming unit when the print medium moved to the pick-up position is transferred in the second direction.

The paper-feeding unit may comprise a paper-feeding cassette having a length corresponding to that of the image forming apparatus body and a width smaller than that of the image forming apparatus body.

According to another aspect of the present invention, there is provided a method of feeding a print medium comprising positioning a print medium at a pick-up position by moving the print medium in a first direction and moving the print medium positioned at the pick-up position in a second direction.

Here, the positioning the print medium at the pick-up position may comprise rotating a pick-up roller in the first direction.

In addition, the positioning the print medium at the pick-up position may comprise: sensing whether the print medium is moved to the pick-up position; and stopping the driving of the pick-up roller in the first direction when the print medium moved to the pick-up position is sensed.

The picking up the print medium may comprise reversely rotating the pick-up roller in the second direction.

In addition, the paper-feeding method may further comprise: sensing whether the picked-up printing medium is admitted into the image forming unit; and stopping the rotational driving of the pick-up roller in the second direction when the print medium is admitted into the image forming unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view to show schematically a conventional portable image forming apparatus;

FIG. 2 is a perspective view to show schematically an image forming apparatus according to an embodiment of the present invention;

FIG. 3 is a block diagram to show schematically a control system according to an embodiment of the present invention;

FIGS. 4 to 8 are cross-sectional views to show a paper-feeding process in sequence; and

FIG. 9 is a view to show schematically a print medium provided with a mark.

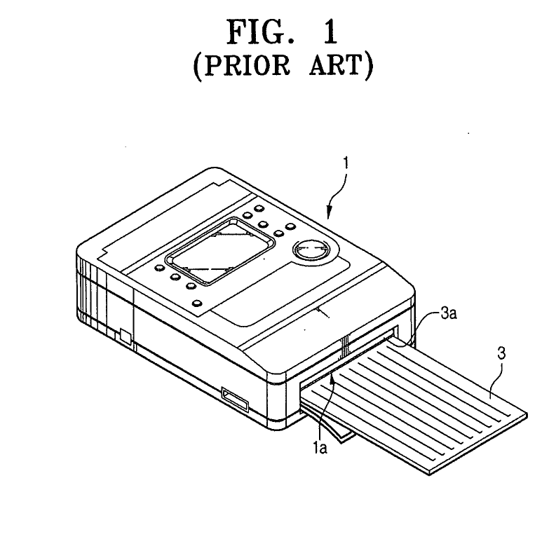

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

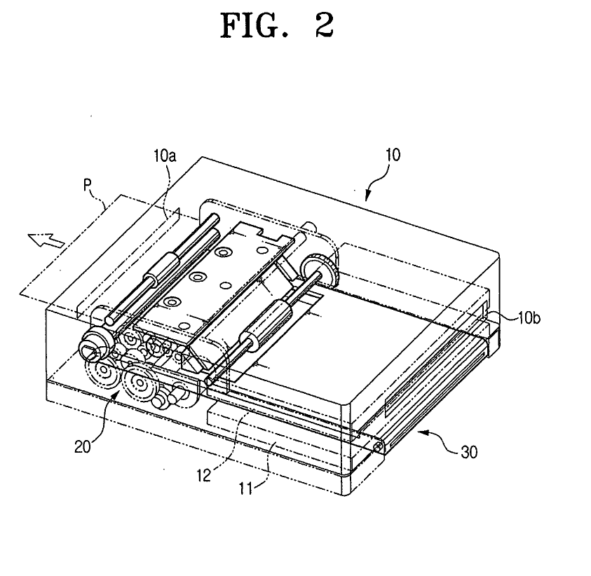

As shown in FIGS. 2 to 4, the image forming apparatus according to an embodiment of the present invention comprises an image forming apparatus body 10, an image forming unit 20, a paper-feeding unit 30, and a controller 60. It is understood that while embodiments of the present invention may use paper as a print medium, and the description below refers to various components in terms of the manipulation of paper (e.g. the paper-feeding unit), other aspects of the present invention may utilize any print medium. According to other aspects of the present invention, paper-feeding unit 30, as well as other components described as manipulating paper, may also manipulate other print media. For example, paper-feeding unit 30 may manipulate other print media as well, such as transparent film. Further, it is understood that in some aspects of the present invention the image forming apparatus is a portable image forming apparatus.

The image forming apparatus body 10 incorporates a series of components for forming an image on a print medium P, such as the image forming unit 20, a battery 11, and a control substrate 12. Here, the battery 11 is provided for supplying a power for image forming operation, and the control substrate 12 is provided for controlling the image forming operation. However, it is understood that the image forming apparatus body may have other components, such as input ports for receiving image data from an external storage device or a wired/wireless connection.

In addition, the image forming apparatus body 10 is formed with first and second paper-discharging ports 10a and 10b for discharging an image-formed print medium to the outside. Other aspects of the present invention may have more or fewer paper-discharging ports.

The image forming unit 20 forms an image corresponding to an image signal inputted from the outside on a print medium P, wherein the image forming unit 20 comprises a print head 21, a platen roller 22, and a feed roller 23.

The print head 21 forms an image on the print medium P. The print head 21 is exemplified as a thermal transfer type head having a plurality of heaters (not shown) for heating the print medium P so as to implement a color image. However, other aspects of the present invention may utilize other types of print heads or printing techniques.

The platen roller 22 compresses the print medium P against the print head 21, thereby supporting the print medium P while printing is performed on the print medium P. As shown in FIG. 7, the platen roller 22 is movably mounted in such a manner as to support the print medium P against the print head 21 only while an image is being formed on the print medium P. This is to prevent the platen roller 22 from interfering with the feeding force of the print medium P given by the feed roller 23.

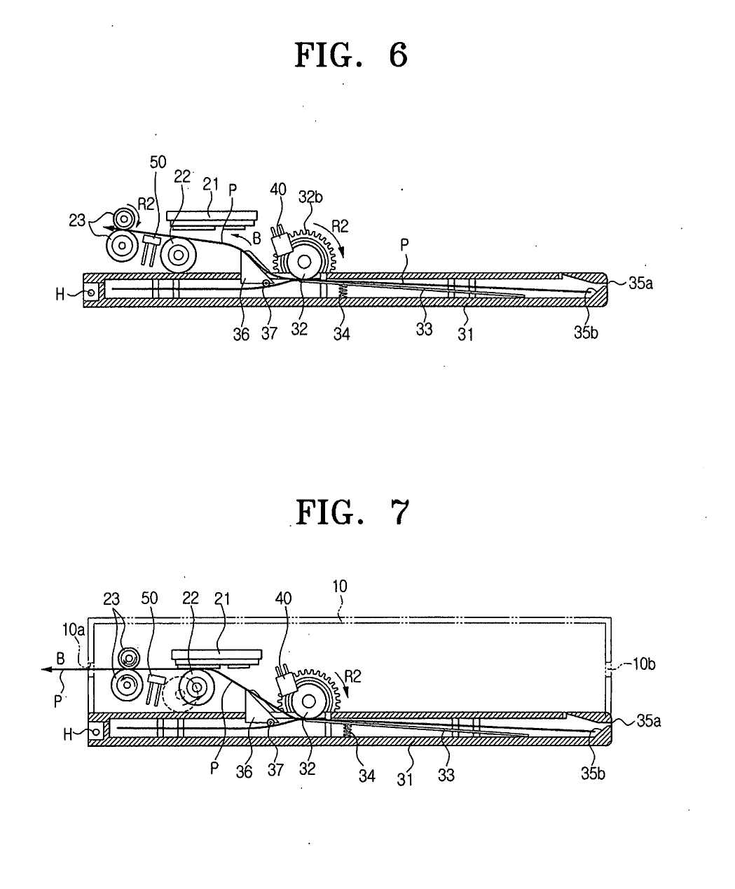

The feed roller 23 serves to feed and discharge an image-formed print medium P to the outside, wherein the feed roller 23 may consist of a pair of rollers. The feed roller 23 may rotate in an “R2” direction as shown in FIG. 6, so that the print medium P is discharged through the first paper-discharge port 10a.

However, the present invention is not limited to this. It is natural that it is possible to configure the feed roller 23 to be bi-directionally rotatable according to the paper-discharge direction of the image-formed print medium P.

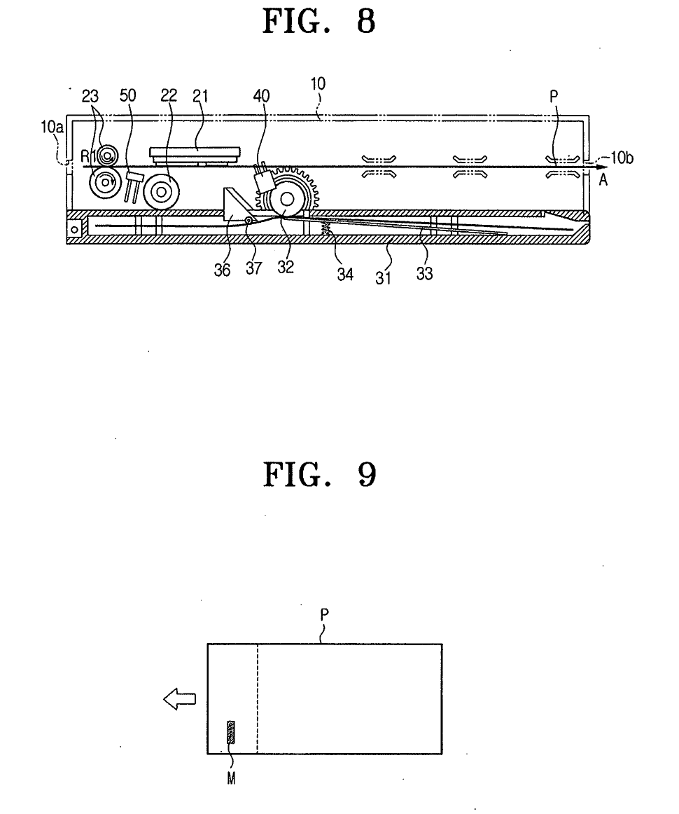

That is, as shown in FIG. 8, the feed roller 23 may rotate in an “R1” direction, thereby moving the image-formed print medium P in an “A” direction, so that the print medium P is discharged through the second paper-discharge port 10b.

Meanwhile, a paper sensor 50 is provided between the print head 21 and the feed roller 23 so as to detect whether the print medium P fed by the paper-feeding unit 30 is admitted to a print position or not. The paper sensor 50 senses the leading edge of the print medium P before the print medium P is admitted into the feed roller 23 so as to determine the timing for positioning the platen roller 22.

That is, if the paper sensor 50 senses the admission of the print medium P. the platen roller 22 moves toward the print head 21 and supports the print medium P.

It is understood that the image forming unit 20 according to other aspects of the present invention may include other or different components, such as components for receiving image data. In addition to other operations, the image forming unit 20 should be able to accept a print medium from the paper-feeding unit 30, to form an image on the print medium P, and to discharge the print medium P to the outside.

The paper-feeding unit 30 is movably mounted in relation to the image forming apparatus body 10, wherein the paper-feeding unit 30 turns the print medium P in a reverse direction at least one time, thereby accomplishing the single-sheet feeding of the print medium P to the image forming unit 20. Such a paper-feeding unit 30 comprises a paper-feeding cassette 31, a pick-up roller 32, a knock-up plate 33, a compression member 34, a retreating path 35, a paper-feeding guider 36, and an idle roller 37.

The paper-feeding cassette 31 is loaded with a predetermined number of print media P in a paper loading position, and at least one end of the paper-feeding cassette 31 is removably installed to the image forming apparatus body 10. More particularly, as shown in FIG. 4, one end of the paper-feeding cassette 31 is rotatably connected to the image forming apparatus body 10 by a hinge H, and the other end is removably connected to the image forming apparatus body 10.

In other words, the paper-feeding cassette 31 is mounted in such a manner as to be capable of being opened/closed in relation to the underside of the image forming apparatus body 10. Here, the paper-feeding cassette 31 preferably has a length corresponding to that of the image forming apparatus body 10 and a width smaller than that of the image forming apparatus body 10. However, it is understood that the paper-feeding cassette may be connected to the image forming apparatus body in any fashion.

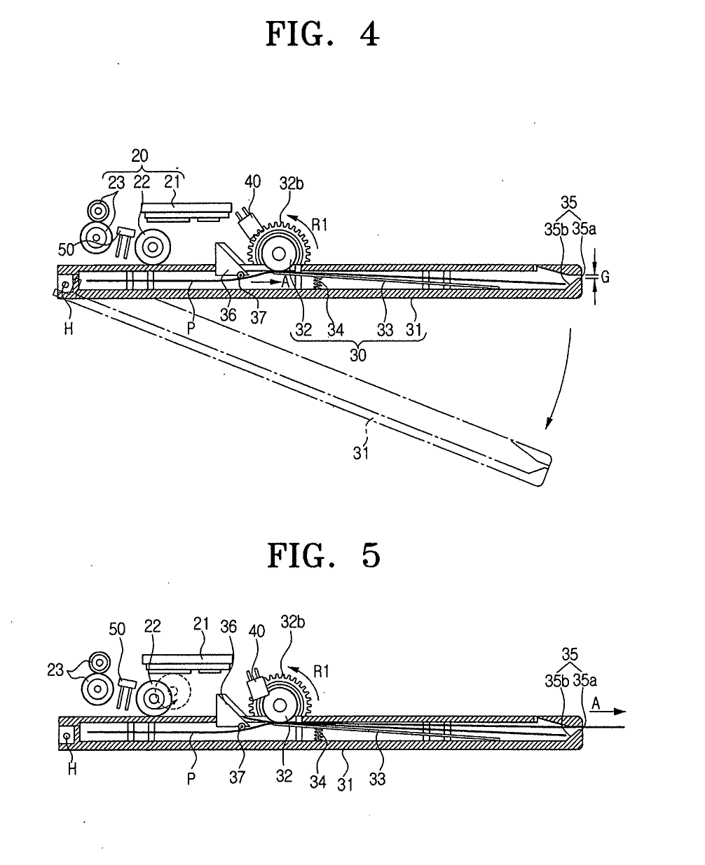

The pick-up roller 32 receives a driving force transmitted from the driving motor 32b through the driving motor 32a, wherein the pick-up roller 32 is installed in the image forming apparatus body 10 in such a manner as to be capable of bi-directionally rotating. In addition, the pick-up roller 32 moves the print medium P to a pick-up position when it rotates in a first direction R1 as shown in FIGS. 4 and 5, and, when it rotates in a second direction R2 as shown in FIGS. 6 and 7, the pick-up roller 32 picks up the print medium P and feeds the print medium P to the image forming unit 20.

The pick-up roller 32 is positioned to be spaced from the leading edge of the print medium P contained in the paper-feeding cassette 31, so that it can move the print medium P to the pick-up position when the pick-up roller 32 reversely rotates at least one time.

The knock-up plate 33 is installed in the paper-feeding cassette 31 in such a manner as to be capable of being lifted or lowered and of elastically supporting the print medium P against the pick-up roller 32. For this reason, the pick-up roller 32 and the print medium P are maintained in contact with each other.

The compression member 34 provides an elastic force for elastically supporting the knock-up plate 33 against the pick-up roller 32.

The retreating path 35 is provided in the image forming apparatus body 10 or the paper-feeding cassette 31 and guides the tail edge of the print medium P moved in the first direction R1 by the pick-up roller 32.

The retreating path 35 comprises a guide slit 35a for guiding the tail edge of the print medium P to the outside, and an inclined part 35b for guiding the tail edge of the print medium P to the guide slit 35a. Here, the inclined part 35b provides a frictional force for single-sheet feeding of a plurality of print media P loaded in the paper-feeding cassette 31, thereby preventing double-sheet feeding.

As shown in FIG. 4, the guide slit 35a has a gap G allowing a sheet of a print medium to pass the guide slit 35a so as to prevent double-sheet feeding.

As shown in FIG. 6, the paper-feeding guider 36 guides the leading edge of the print medium P, which (as shown in FIG. 5) has moved to the pick-up position by the rotation of the pick-up roller 32 in the second direction R1, to the image forming unit 20.

The paper-feeding guider 36 is provided between the image forming apparatus body 10 and the paper-feeding cassette 31 to be opposite to the pick-up roller 32, and more preferably to be lowered by a predetermined depth and project into the paper-feeding cassette 31. This is to assure that the paper-feeding guider 36 guides the leading edge of the print medium P to be smoothly admitted into the image forming unit 20 while the print medium P is being fed.

Meanwhile, an idle roller 37 is rotatably mounted on the paper-feeding guider 36 between the paper-feeding cassette 31 and the image forming apparatus body 32, wherein the idle roller 37 comes into contact with the print surface of a print medium P moved in the “A” direction by the rotation of the pick-up roller 32 in the first direction R1 and guides the print medium P.

The idle roller 37 is provided so as to prevent the print surface of the print medium P from being damaged by friction, for example, by friction such as scratch caused by the paper-feeding guider 36 occurring while the print medium P is transferred.

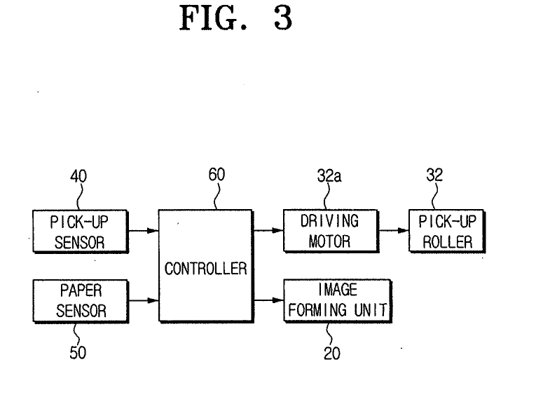

As shown in FIG. 3, the controller 60 receives input from the pick-up sensor 40 and the paper sensor 50 and controls the driving of the pick-up roller 32 and the image forming unit 20. In particular, the controller 60 controls the rotating force of the feed roller 23, the positional displacement of the platen roller 22, the image forming operation of the print head 21, etc., in response to the information sensed by the paper sensor 50 as described above. However, it is understood that according to other aspects, the controller 60 may receive input from any source, such as from the outside, and may control operation of any component of the image formation apparatus.

In addition, the controller 60 controls the rotation of the pick-up roller 32 in the first and second directions R1 and R2 on the basis of information sensed by a pick-up sensor 40, wherein the pick-up sensor 40 is positioned between the pick-up roller 32 and the paper-feeding guider 36 and senses a print medium P at the pick-up position. At this time, the controller 60 controls the driving motor 32a connected to the pick-up roller 32 so as to control the rotating direction of the pick-up roller 32.

The controller 60 stops the driving of the pick-up roller 32 on the basis of a sensing signal for the print medium P, which is applied from the paper sensor 50. This is to prevent tearing and poor image formation of the print medium P caused by the difference in driving force between the pick-up roller 32 and the feed roller 23. If the pick-up roller 32 and the feed roller 23 have different driving forces, the print medium P may become stretched or compressed, negatively impacting formation of an image on the print medium P and potentially damaging the print medium P as well.

Meanwhile, as shown in FIG. 9, the leading edge of the print medium P has a mark M which is sensed by the pick-up sensor 40. The mark M is located in a non-image forming area of the print medium M, so that the mark does not interfere with an image to be formed. In addition, the mark M of the print medium P can also be sensed by the paper sensor 50.

Now, the paper-feeding and image forming operations of the inventive image forming apparatus are described with reference to the accompanying drawings.

As shown in FIG. 4, the top print medium P among the print media P loaded in the paper-feeding cassette 31 is in contact with the pick-up roller 32 by being elastically supported by the knock-up plate 33, which is compressed by the compression member 34. At this time, if an image forming operation signal is inputted from the outside, the pick-up roller 32 rotates in the “R1” direction, thereby moving the print medium P in the “A” direction.

The tail edge of the print medium P moving in the “A” direction is guided along the inclined part 35b, separated as a single sheet through the guide slit 35a, and then transferred to the outside of the paper-feeding cassette 31 as shown in FIG. 5. At this time, the print surface of the print medium P is being transferred by the idle roller 37 without friction at the leading edge of the print medium P.

Thereafter, if the mark M at the leading edge of the print medium P as shown in FIG. 9 is sensed by the pick-up sensor 40, the driving of the pick-up roller 32 in the first direction R1 is stopped and the pick-up roller 32 reversely rotates in the second direction R2.

At this time, as shown in FIG. 6, the leading edge of the print medium P is smoothly admitted into the image forming unit 20 by the paper-feeding guider 37 and the elasticity of the knock-up plate 33. The print medium P fed to the image forming unit 20 in this manner is continuously moved by the rotation of the pick-up roller in the second direction R2, thereby being admitted into the feed roller 23.

Here, if the leading edge of the print medium P is sensed by the paper sensor 50, which is interposed between the feed roller 23 and the print head 21, the platen roller 22 moves toward the print head 21 as shown in FIG. 7.

The print medium P supported by the platen roller 22 in this manner is continuously transferred by the feed roller 23 after a predetermined image is formed on the print medium P by the print head 21, thereby being discharged to the outside. When the paper sensor 50 senses the leading edge of the print medium P, the pick-up roller 32 stops the rotational driving in the second direction R2.

Meanwhile, the image-formed print medium P is discharged through the first paper discharge port 10a of the image forming apparatus body 10 as shown in FIG. 7 or through the second paper discharge port 10b as shown in FIG. 8, depending on the rotating direction of the feed roller 23.

As described above, according to aspects of the present invention, it is not required to secure a space for mounting a paper-feeding unit because such a paper-feeding unit is provided within the image forming apparatus body. As a result, it is possible to provide a compact image forming apparatus. In addition, because the paper-feeding unit can be easily moved even if it is provided within the image forming apparatus body, the image forming apparatus can be easily and conveniently carried. These features are useful for portable image forming apparatuses, where size and ease of portability are important considerations.

Although representative embodiments of the present invention have been shown and described in order to exemplify the principle of the present invention, the present invention is not limited to the specific embodiments. It will be understood that various modifications and changes can be made by one skilled in the art without departing from the spirit and scope of the invention as defined by the appended claims. Therefore, it shall be considered that such modifications, changes and equivalents thereof are all included within the scope of the present invention.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus comprising:
an image forming apparatus body;
an image forming unit provided within the image forming apparatus body; and
a paper-feeding unit movably installed in relation to the image forming apparatus body, the paper-feeding unit feeding a print medium to the image forming unit after turning the print medium in a reverse direction at least one time.

2. The image forming apparatus as claimed in claim 1, wherein the paper-feeding unit comprises a pick-up roller mounted within the image forming apparatus body in such a manner as to be bi-directionally rotatable, so that when the pick-up roller rotates in a first direction, the pick-up roller moves the print medium to a pick-up position and when the pick-up roller rotates in a second direction, the pick-up roller unit picks up the print medium at the pick-up position and feeds the print medium to the image forming unit.

3. The image forming apparatus as claimed in claim 2, further comprising:
a pick-up sensor to sense whether the print medium has moved to the pick-up position; and
a controller to selectively control the driving direction of the pick-up roller in the forward/reverse direction based upon a first sensing signal from the pick-up sensor.

4. The image forming apparatus as claimed in claim 3, further comprising a paper sensor to sense whether the print medium fed by the pick-up roller is admitted into a print position in the image forming unit, wherein the controller stops the driving of the pick-up roller based upon a second sensing signal for the print medium, which is applied from the print sensor.

5. The image forming apparatus as claimed in claim 2, wherein the pick-up roller is spaced apart from the print medium received in the paper-feeding unit, so that the pick-up roller moves the print medium to the pick-up position when the pick-up roller reversely rotates at least one time.

6. The image forming apparatus as claimed in claim 2, wherein the image forming apparatus or the paper-feeding unit is provided with a retreating path for the tail edge of the print medium moved in the first direction by the pick-up roller.

7. The image forming apparatus as claimed in claim 6, wherein the retreating path comprises a guide slit provided in the image forming apparatus body or the paper-feeding unit so as to guide the tail edge of the print medium to the outside.

8. The image forming apparatus as claimed in claim 7, wherein the retreating path further comprises an inclined part to guide the tail edge of the print medium moving in the first direction to the guide slit, and wherein the inclined part provides a frictional force so as to prevent double-feeding.

9. The image forming apparatus as claimed in claim 6, further comprising a paper-feeding guider, provided between the image forming apparatus body and the paper-feeding unit, to guide the leading edge of the print medium to the image forming unit when the print medium moved to the pick-up position is transferred in the second direction.

10. The image forming apparatus as claimed in claim 5, further comprising a paper-feeding guider provided within the image forming apparatus body and the paper-feeding unit to guide the leading edge of the print medium to the image forming unit when the print medium moved to the pick-up position is transferred in the second direction.

11. An image forming apparatus as claimed in claim 2, wherein the paper-feeding unit comprises a paper-feeding cassette having a length corresponding to that of the image forming apparatus body and a width smaller than that of the image forming apparatus body.

12. The image forming apparatus as claimed in claim 2, further comprising a paper-feeding guider, provided between the image forming apparatus body and the paper-feeding unit, to guide the leading edge of the print medium to the image forming unit when the print medium moved to the pick-up position is transferred in the second direction.

13. The image forming apparatus as claimed in claim 11, wherein the paper-feeding cassette is rotatably attached to the paper-feeding unit.

14. The image forming apparatus as claimed in claim 11, further comprising:
a knock-up plate installed in the paper-feeding cassette for supporting a print medium against a pick-up roller; and
a compression member installed in the paper-feeding cassette for providing support to the knock-up plate.

15. The image-forming apparatus as claimed in claim 1, wherein the image forming apparatus body further comprises a first discharge port to discharge an image-formed print medium.

16. The image-forming apparatus as claimed in claim 1, wherein the image forming apparatus body further comprises a second discharge port to discharge an image-formed print medium.

17. The image-forming apparatus as claimed in claim 2, wherein the paper-feeding unit is movably attached to the underside of the image forming apparatus.

18. A method of feeding a print medium comprising:
positioning a print medium at a pick-up position by moving the print medium in a first direction; and
moving the print medium positioned at the pick-up position in a second direction.

19. The method of feeding a print medium as claimed in claim 18, wherein the positioning the print medium at the pick-up position comprises rotating a pick-up roller in the first direction.

20. The method of feeding a print medium as claimed in claim 19, wherein the positioning the print medium at the pick-up position comprises:
sensing whether the print medium is moved to the pick-up position; and
stopping the rotational driving of the pick-up roller in the first direction when the print medium moving to the pick-up position is sensed.

21. The method of feeding a print medium as claimed in claim 18, wherein the moving the print medium comprises rotating the pick-up roller in the second direction.

22. The method of feeding a print medium as claimed in claim 21, further comprising:
sensing whether the picked-up printing medium is admitted into the image forming unit; and
stopping the rotational driving of the pick-up roller in the second direction when the print medium is admitted into the image forming unit.

23. A paper-feeding unit for use with an image forming unit, comprising:
a bi-directionally rotatable pick-up roller mounted within the paper-feeding unit so that when the pick-up roller rotates in a first direction, the pick-up roller moves the print medium to a pick up position, and when the pick-up roller rotates in a second direction, the pick-up roller picks up the print medium at the pick-up position and feeds the print medium to an image forming unit; and
wherein the paper-feeding unit can be incorporated within a body of an image forming apparatus.

24. The paper-feeding unit as claimed in claim 23, further comprising:
a pick-up sensor to sense whether the print medium has moved to the pick-up position; and
a controller to selectively control the rotation of the pick-up roller in the first/second direction on the basis of a sensing signal from the pick-up sensor.

25. A paper-feeding unit as claimed in claim 23, wherein the paper-feeding unit is adapted for use with a portable image forming apparatus.

26. An image-forming apparatus, comprising:
an image forming apparatus body;
an image forming unit provided within the image forming apparatus body, comprising a print head to form an image upon a print medium; and
a paper-feeding unit to feed a print medium, wherein the print medium, in a paper loading position, overlaps the print head in a direction substantially perpendicular to a first and second direction, and wherein the print medium does not substantially overlap the print head upon being moved in the first direction to a pick-up position, and wherein the print medium is in a position so as to receive an image from the print head upon being moved in the second direction.

27. An image-forming apparatus, comprising:
an image forming apparatus body;
an image forming unit provided within the image forming apparatus body, comprising a print head to form an image upon a print medium; and
a paper-feeding unit to feed a print medium, comprising a pick-up roller, wherein the print medium, in a paper-loading position, overlaps said pick-up roller in a direction substantially perpendicular to a first and second direction, and wherein the print medium does not substantially overlap said pick-up roller upon being moved, by the pick-up roller, in the first direction to a pick-up position, and wherein the print medium is in a position so as to receive an image from the print head upon being moved, by the pick-up roller, in the second direction.

28. A method of feeding a print medium to an image forming unit, comprising:
rotating a pick-up roller in a first direction to move a print medium, located in a paper-feeding unit, to a pick-up position; and
rotating a pick-up roller in a second direction to feed the print medium from the pick-up position to an image forming unit.
